(19) United States
(12) Patent Application Publication
(10) Pub. No.: US 2004/0039835 A1
(43) Pub. Date: Feb. 26, 2004

(54) Method and apparatus for transferring general purpose control information between processors

(75) Inventors: Scott C. Glenn, Austin, TX (US); Nicholas J. Kohout, Austin, TX (US); Brian R. Mears, Tempe, AZ (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/225,329

(22) Filed: Aug. 21, 2002

(51) Int. Cl. G06F 15/167

(52) U.S. Cl. 709/231; 709/253

(57) ABSTRACT

General purpose control information is transmitted in a serial stream between digital processors.

### BACKGROUND OF THE INVENTION

General-purpose inputs/outputs (GPIOs) are signals that may be used to provide a variety of control functions between digital processors. For example, GPIOs may be used to transfer interrupts between processors. Many other inter-processor control functions may also be performed using GPIOs. Often, an individual GPIO will consist of a single bit of information, although multiple bit GPIOs may also be used. In the past, dedicated terminals were provided on a processor (e.g., leads on a processor package, bond pads on a die carrying the processor, etc.) for use in communicating GPIOs to other processors. The dedicated terminal associated with a particular GPIO would then be connected to a corresponding terminal on another processor through a dedicated signal line. As the number of GPIOs between processors increases, however, the use of dedicated terminals and dedicated signal lines can become difficult and expensive to implement.

### BRIEF DESCRIPTION OF THE DRAWINGS

FIG. 1 is a block diagram illustrating a multiple processor system in accordance with an embodiment of the present invention;

FIG. 2 is a block diagram illustrating an interface for use with a digital processor in accordance with an embodiment of the present invention;

FIG. 3 is a block diagram illustrating a portion of a multiprocessor system in accordance with an embodiment of the present invention;

FIG. 4 is a block diagram illustrating a portion of a multiprocessor system in accordance with another embodiment of the present invention; and

FIG. 5 is a timing diagram illustrating a transfer of general-purpose control information over a bi-directional transmission medium in accordance with an embodiment of the present invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within the disclosed embodiments maybe modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

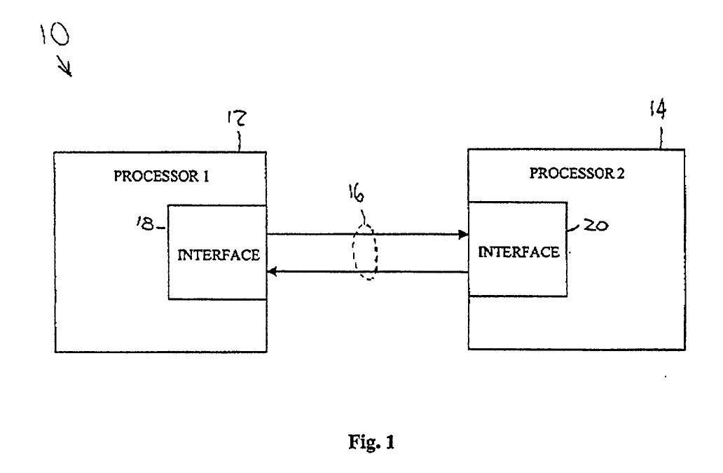

FIG. 1 is a block diagram illustrating a multiple processor system 10 in accordance with an embodiment of the present invention. As illustrated, the multiple processor system 10 includes: a first processor 12, a second processor 14, and a bi-directional transmission medium 16 coupling the first and second processors 12, 14. The first and second processors 12, 14 may include any form of digital processor including, for example, a general purpose microprocessor, a digital signal processor, a reduced instruction set computer (RISC) processor, a complex instruction set computer (CISC) processor, an application specific integrated circuit (ASIC), a field programmable gate array (FPGA), an application processor, a micro-controller, and/or others. Hybrid digital/analog processors may also be used. The first and second processors 12, 14 may be individually packaged or the full multiple processor system 10 may be implemented within a common package. In at least one approach, the first and second processors 12, 14 and the bi-directional transmission medium 16 are all implemented on a common die. The bi-directional transmission medium 16 is operative for providing communication between the first and second processors 12, 14. As will be described in greater detail, the bi-directional transmission medium 16 may be used to provide serial communication of general-purpose control information (e.g., GPIOs, etc.) between the processors 12, 14. In addition, the bi-directional transmission medium 16 may also be used to provide serial communication of user data between the processors 12, 14 (although, in at least one embodiment, other means are provided for communication of user data between the processors 12, 14). In the illustrated embodiment, processors 12, 14 may include a corresponding interface 18, 20 to support communication over the bi-directional transmission medium 16. Although only two processors are illustrated in FIG. 1, it should be appreciated that the inventive principles also have application in systems having three or more interconnected processors.

The bi-directional transmission medium 16 may include any form of transmission medium capable of carrying digital information in both directions between the processors 12, 14. In at least one approach, the bi-directional transmission medium 16 includes two independent unidirectional transmission structures; one to provide information transfer from the first processor 12 to the second processor 14 and the other to provide information transfer from the second processor 14 to the first processor 12. These unidirectional transmission structures may include, for example, one or more conductive signal lines. Other forms of bi-directional transmission medium may alternatively be used. For example, a medium that permits two-way communication on a single structure may be used. Also, optical or wireless media may be used. If communication is only required in a single direction, the bi-directional transmission medium 16 may be replaced by a unidirectional transmission medium.

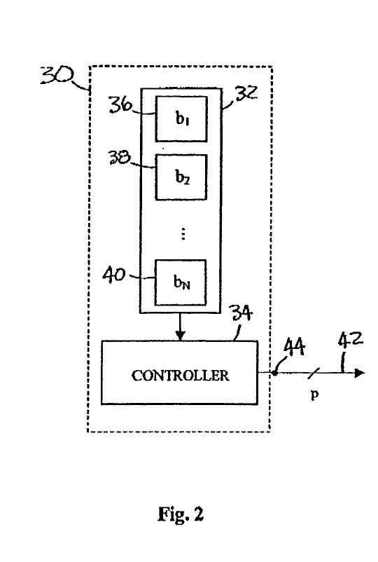

FIG. 2 is a block diagram illustrating an interface 30 for use within a digital processor in accordance with an embodiment of the present invention. As illustrated, the interface 30 includes an output control register 32 and an interface controller 34. The output control register 32 is operative for storing general-purpose control information for the corresponding digital processor. This general-purpose control information includes information that may be used to provide one or more control functions within another digital processor (e.g., GPIOs, request or acknowledge to power down, etc.). Although illustrated as a single unit, the output control register 32 may consist of multiple registers operably coupled together. In the illustrated embodiment, the output control register 32 includes a plurality of addressable storage locations 36, 38, 40 that are capable of storing a single bit of digital control information. The number of storage locations within the output control register 32 will typically depend on the quantity and type of control information that may need to be transferred to another processor. Although illustrated as including single bit storage locations, the output control register 32 may alternatively (or additionally) include multiple-bit addressable storage locations.

A data item (e.g., a single bit or multi-bit word) stored in a storage location of the output control register 32 may be individually modified by other functionality within the corresponding processor (e.g., the main control unit within the processor, etc.). As will be appreciated, changes may be made to control information within the output control register 32 when corresponding control actions or indications are desired to be made to another processor. For example, in one implementation, the interface 30 is implemented within a radio baseband processor that is in communication with a multimedia processor. In such an implementation, the data bit b₁ stored in storage location 36 of output control register 32 may be operative for indicating to the multimedia processor whether or not a radio receive function is presently active within the baseband processor. When the radio receive function is activated, therefore, the bit value stored within storage location 36 maybe changed from, for example, a logic zero to a logic one. Any number of different control bits or control words may be modified in this manner.

The controller 34 is operative for transmitting the general purpose control information stored in the output control register 32 to another processor, in a serial stream, in response to a change in value of at least one bit stored within the output control register 32. For example, in the illustrated embodiment, should the value stored within storage location 36 of output control register 32 change from a logic zero to a logic one, the controller 34 will cause the contents of the output control register 32 to be transmitted in a serial stream onto a transmission medium 42 coupling the local processor to the other processor. The other processor may then receive the serial stream and appropriately store the corresponding control information in an input control register therein. A storage location within the input control register of the other processor may have a predetermined control purpose within the other processor. Because the general-purpose control information is transmitted serially, a dedicated terminal does not have to be provided on the corresponding processor for a bit of control information to be transferred. Likewise, a dedicated signal line does not have to be provided for a bit to be transferred. In one approach, the control information stored in the output control register 32 is transferred least significant bit(s) first to the other processor. Although illustrated as part of an interface portion (i.e., interface 30) of a corresponding processor, the controller function described above may alternatively be implemented within another portion of the processor (e.g., within a main control unit, etc.).

In the illustrated embodiment, the transmission medium 42 coupling the local processor to the other processor includes one or more conductive signal lines (p≧1). The signal line(s) may be implemented in any of a variety of ways including using, for example, etched lines, microstrip lines, stripline lines, coplanar waveguide, discrete wires, ribbon cable, shielded cabling (e.g., coaxial cable, etc.), bus structures, differential lines, and/or others. For a packaged processor, an individual connection node 44 (e.g., a lead, a pin, a solder bump, a ceramic column, a bond pad, etc.) may be included on the package of the processor to provide a connection to the signals lines. Other forms of transmission media may alternatively be used including, for example, optical or wireless media (in which case corresponding radiator or transducer elements may be implemented within the processors).

As used herein, the term “serial stream” is not limited to a single stream of individual bits. For example, in an embodiment where the transmission medium 42 includes multiple signal lines, a serial stream may include a stream where multiple bits are transmitted at a time (e.g., one on each line) for multiple successive instants in time. Such an arrangement may be characterized as a serial stream of multi-bit symbols. Similarly, even if only a single line is provided, a serial stream could include a stream of multi-bit symbols using, for example, an appropriate modulation scheme. Other forms of serial stream are also possible.

If the transmission medium 42 is dedicated to the transmission of control information to the other processor, then the transfer of control information may commence immediately upon detection of a change in the output control register 32. If the transmission medium 42 is also used to transmit other forms of information (e.g., user data, flow control messages, etc.), then a multiple access scheme (e.g., a priority scheme, etc.) may need to be implemented within the local processor. In one approach, interrupts are generated by edge detectors that are coupled to corresponding storage location in the output control register 32. In another approach, the interrupts are generated by the functionality within the local processor (e.g., the main control unit, etc.) that modifies the bit values within the output control register 32. Other techniques for generating interrupts may also be used. In a system using such interrupts, the output control information may be transmitted in response to an interrupt.

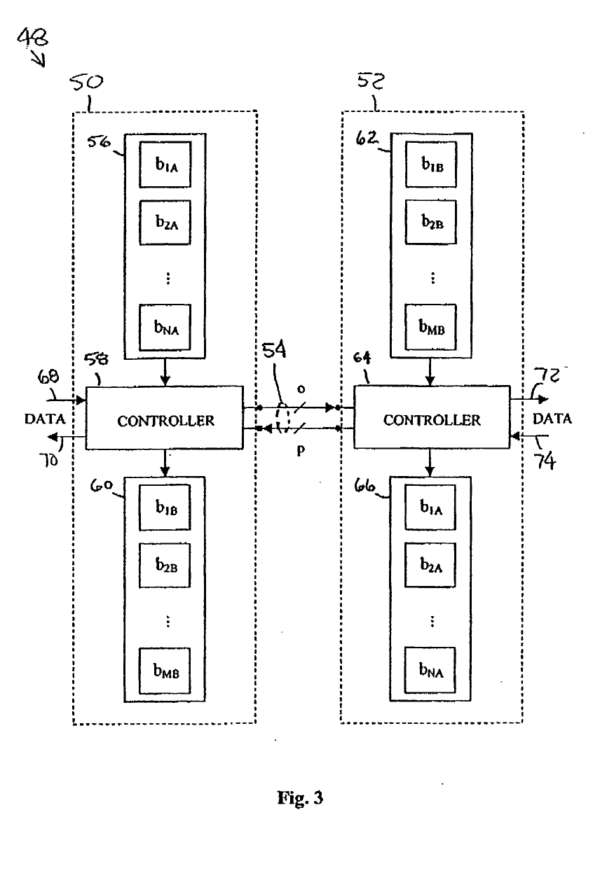

FIG. 3 is a block diagram illustrating a portion of a multiprocessor system 48 in accordance with an embodiment of the present invention. The multiprocessor system 48 includes a first interface 50 associated with a first processor communicating with a second interface 52 associated with a second processor through a bi-directional transmission medium 54. As illustrated, the first interface 50 includes an output control register 56, a controller 58, and an input control register 60. Similarly, the second interface 52 includes an output control register 62, a controller 64, and an input control register 66. The output control register 56 and the controller 58 of the first interface 50 operate in a similar manner to the corresponding elements of FIG. 2 to deliver general purpose control information to the second processor in a serial stream. The controller 64 within the second interface 52 is programmed to store the control information received in a serial stream from the first processor to the input control register 66. In one approach, the input control register 66 of the second interface 52 includes a corresponding storage location for a storage location of the output control register 56 of the first interface 50 (with the corresponding control functions). The output control register 62 and controller 64 of the second interface 52 and the controller 58 and input control register 60 of the first interface 50 may also be operative for transferring general purpose control information in the reverse direction in the manner described above.

The bi-directional transmission medium 54 may include any form of transmission medium capable of carrying digital information in both directions between the corresponding processors. In the illustrated embodiment, the bi-directional 10 transmission medium 54 includes one or more conductive signal lines (i.e., o≧1 in FIG. 3) for transmitting information from the first processor to the second processor and one or more conductive signals lines (i.e., p≧1 in FIG. 3) for transmitting information from the second processor to the first processor. The number of signal lines carrying information in one direction does not have to be the same as the number carrying information in the other direction. As described previously, other types of transmission media may alternatively be used.

In addition to the general-purpose control information, the first and second interfaces 50, 52 may also transmit user data to one another via the bi-directional transmission medium 54. In the illustrated embodiment, for example, the controller 58 receives user data from other functionality within the first processor through at least one path 68, for delivery to the second processor. The controller 58 may then transmit the user data to the second processor in a serial stream through the bi-directional transmission medium 54. In at least one embodiment, transmission of general-purpose control information is given priority over transmission of user data. Thus, if a bit of information in the output control register 56 changes value while a transfer of user data is in progress, the transfer of user data may be suspended until the control information within the output control register 56 has been transferred. The controller 58 may wait until a current byte (or other fixed quantity) of user data has been transferred before initiating the transfer of control information. After the control information has been transferred, the transfer of user data can be recommenced. Appropriate identifiers may be included with the user data and/or control information being transmitted through the bi-directional transmission medium 54 to allow the interface at the other end to identify the type of information being received. This can include, for example, appropriate header information before the corresponding stream and/or trailer information after the corresponding stream.

In at least one embodiment, message flow control (MFC) messages are also delivered between processors via the bi-directional transmission medium 54. MFC messages are used to control the flow of data by sending stop and start messages to pause and resume data transmission, respectively. In one approach, an MFC message is given priority over both general-purpose control information and user data. However, if the transfer of general-purpose control information has already commenced when it is determined that an MFC message needs to be sent, the transfer may be allowed to complete before the MFC message is sent. As will be appreciated, other forms of information may also be transmitted between processors on the bi-directional transmission medium 54. As described above, appropriate identifiers maybe included with the data stream to identify the type of information being delivered.

When user data is transferred to the second processor through the bi-directional transmission medium 54, the controller 64 will identify the received signal as user data and deliver the corresponding user data to appropriate functionality within the second processor through at least one path 72. A similar transfer of user data may also take place in the reverse direction. That is, user data may be delivered to controller 64 through at least one path 74, then be transmitted through the bi-directional transmission medium 54 to the first processor, and then be directed to appropriate functionality within the first processor through at least one path 70.

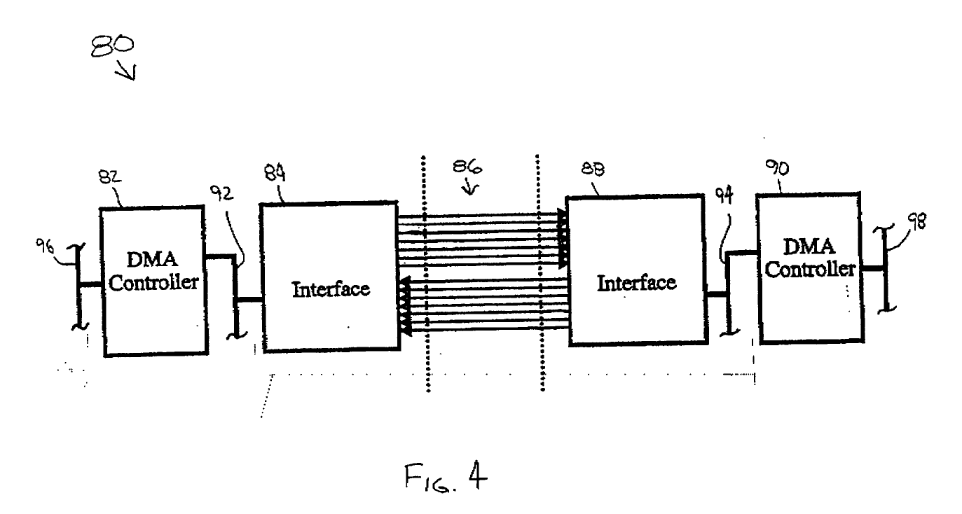

FIG. 4 is a block diagram illustrating a portion of a multiprocessor system 80 in accordance with an embodiment of the present invention. As shown, the system 80 includes: a first direct memory access (DMA) controller 82, a first interface 84, a bi-directional transmission medium 86, a second interface 88, and a second DMA controller 90. The first DMA controller 82 and first interface 84 are associated with a first processor and the second DMA controller 90 and second interface 88 are associated with a second processor. The first and second interfaces 84, 88 may be the same or similar to the interfaces described previously. The first and second DMA controllers 82, 90 are operative for providing a direct link between a corresponding interface 84, 88 and a memory associated with the respective processor. Thus, the DMA controllers 82, 90 allow user data to flow directly to/from memory without having to pass through a corresponding control unit of a processor. In the illustrated embodiment, DMA controllers 82, 90 communicate with a corresponding interface 84, 88 through a peripheral bus 92, 94. Similarly, DMA controllers 82, 90 communicate with memory through a system bus 96, 98. As will be appreciated, other coupling schemes may alternatively be used.

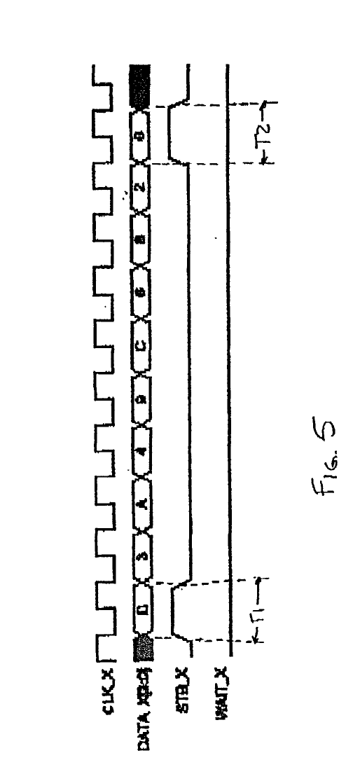

In the embodiment of FIG. 4, the bi-directional transmission medium 86 includes two unidirectional transmission structures, each having seven parallel lines. In both directions, four of the lines are information lines, one is a clock line, one is a strobe line, and one is a wait line. Other arrangements are also possible. The information lines are operative for carrying information (e.g., general purpose control information, user data, and/or other forms of information) from one processor to another in a serial stream. Although illustrated with four information lines in both directions, it should be appreciated that any number of such lines may be used (i.e., one or more in each direction). The clock line carries a clock signal to provide synchronization for information on the information lines. The strobe line provides an indication to a receiver when the information currently on the information lines is overhead as opposed to information being transferred to the other processor. The wait line is used to implement a user data flow control technique known as direct flow control (DFC). For example, in one approach, the wait line may be held at a first logic value (e.g., a logic 1) by the receiver when the receiver is unable to accept more user data from the medium 86 and at a second logic value (e.g., a logic 0) when the receiver is ready to accept more user data. As described previously, other forms of bi-directional transmission medium may alternatively be used. In at least one embodiment, a single unidirectional transmission medium is used. FIG. 5 is a timing diagram illustrating a transfer of general-purpose control information over the bi-directional transmission medium 86 in accordance with an embodiment of the present invention. As shown, information is transmitted serially across the medium 86, four bits at a time (i.e., one bit on an information line for a clock cycle). In one approach, a number of channels are defined on the medium 86 that carry a corresponding type of information. For example, one or more channels may be assigned to carry general purpose control information, one or more channels may be assigned to carry user data, one or more channels may be assigned to carry MFC messages, and so on. The channels are distinguished from one another using control information transmitted on the information lines. For example, as shown in FIG. 5, the strobe line (STB_X) transitions to logic high during interval T1 to indicate that the value on the information lines (DATA_X[3,0]) is a control value. The illustrated value is hexadecimal D (i.e., 13) to indicate that channel 13 (a general purpose control data channel) is about to transmit. In the illustrated embodiment, the output control register within the interface 84 stores 32 bits of general-purpose control information. Thus, as shown, all of the output control information is transmitted within the subsequent eight clock cycles (i.e., four bits at a time). During interval T2, the strobe line (STB_X) once again transitions to logic high. The corresponding overhead value on the information lines (DATA_X[3,0]) is zero, which indicates that the present channel has just ended. Other channels may be transmitted in a similar fashion. In addition, a priority scheme may be implemented wherein one channel has transmission priority over another (e.g., if channel 13 is ready to transmit, it will be transmitted before a user data channel).

Although the present invention has been described in conjunction with certain embodiments, it is to be understood that modifications and variations may be resorted to without departing from the spirit and scope of the invention as those skilled in the art readily understand. Such modifications and variations are considered to be within the purview and scope of the invention and the appended claims.

What is claimed is:

1. A digital processor comprising:
an output register to store output control information; and
a controller programmed to transmit said output control information in a serial stream to another digital processor in response to a change in value of at least one bit of said output control information in said output register.

2. The digital processor of claim 1, comprising:
a package to house said digital processor, said package including at least one connection node to connect said digital processor to one or more signal lines to carry said serial stream of output control information to said another digital processor.

3. The digital processor of claim 1, comprising:
an input register to store input control information, wherein said controller is programmed to transfer input control information received in a serial stream from said another digital processor into said input register.

4. The digital processor of claim 3, comprising:
a package to house said digital processor, said package including at least one connection node to connect said digital processor to one or more signal lines that carry said serial stream of input control information to said digital processor.

5. The digital processor of claim 1, wherein:
said controller is programmed to transmit said output control information to said another digital processor through a first transmission structure, wherein said controller is also programmed to transmit user data in a serial stream to said another digital processor through said first transmission structure.

6. The digital processor of claim 5, wherein:
said controller is programmed to give transmission priority to said output control information over said user data.

7. The digital processor of claim 1, wherein:
said register and said controller are part of an interface portion of said digital processor.

8. The digital processor of claim 1, wherein:
said output control information includes output control bits to perform predetermined control functions within the another digital processor.

9. A method to transfer information between digital processors, comprising:
storing control information within a register in a first processor; and
transmitting said control information in a serial stream to a second processor in response to a change in value of at least one bit of said control information in said register.

10. The method of claim 9, wherein:
transmitting said control information includes transmitting said control information through a first transmission medium, said method further comprising transmitting user data in a serial stream to the second processor through the first transmission medium.

11. The method of claim 10, comprising:
giving transmission priority to said control information over said user data.

12. The method of claim 9, wherein:
transmitting said control information to a second processor includes sensing an interrupt indicating that a bit of said control information in said register has changed value and transmitting said control information in response to said interrupt.

13. The method of claim 9, wherein:
transmitting said control information includes transmitting said control information through a transmission medium including at least one conductive signal line.

14. The method of claim 9, comprising:
receiving said serial stream of control information in the second processor; and
storing said control information within an input register in the second processor, storage locations in said input register having a predetermined control purpose.

15. A multiple processor system, comprising:
a first processor;
a second processor; and
a transmission medium between said first and second processors;
wherein said first processor comprises:
a first output register to store first control information; and
a first controller programmed to transmit said first control information to the second processor in a serial stream, via said transmission medium, in response to a change in value of at least one bit of said first control information in said first output register,
wherein said transmission medium comprises another unidirectional transmission structure to carry information from the second processor to the first processor.

16. The multiple processor system of claim 15, wherein said second processor comprises:
a second controller programmed to store first control information received in a serial stream from said first processor within a first input register in said second processor, said first input register having individual storage locations with predetermined control functions within said second processor.

17. The multiple processor system of claim 16, wherein said second processor comprises:
a second output register to store second control information, wherein said second controller is programmed to transmit said second control information to the first processor in a serial stream, via said transmission medium, in response to a change in value of at least one bit of said second control information in said second output register.

18. The multiple processor system of claim 17, wherein:
said first controller is programmed to store second control information received in a serial stream from said second processor within a second input register in said first processor, said second input register having individual storage locations with predetermined control functions within said first processor.

19. The multiple processor system of claim 15, wherein:
said transmission medium includes at least one signal line.

20. The multiple processor system of claim 15, wherein:
said transmission medium comprises a unidirectional transmission structure to carry information from the first processor to the second processor.

21. The multiple processor system of claim 20, wherein:
said unidirectional transmission structure having a strobe line and at least one information line, said strobe line to indicate when information on said at least one information line is overhead.

22. The multiple processor system of claim 20, wherein:
said transmission medium comprises another unidirectional transmission structure to carry information from the second processor to the first processor.

23. The multiple processor system of claim 15, wherein:
said transmission medium includes an optical medium.

24. The multiple processor system of claim 15, wherein:
said transmission medium includes a wireless medium.

25. The multiple processor system of claim 15, wherein:
said first controller is also programmed to transmit user data to the second processor in a serial stream via said transmission medium.

26. The multiple processor system of claim 25, wherein:
said first controller is programmed to transmit overhead information before said serial stream of first control information to identify said first control information.

27. The multiple processor system of claim 26, wherein:
said overhead information includes a channel identifier.

28. The multiple processor system of claim 15, wherein:
said first controller is coupled to a direct memory access (DMA) controller to provide direct access to a memory associated with the first processor.
